(19) United States
(12) Patent Application Publication
(10) Pub. No.: US 2003/0233776 A1
(43) Pub. Date: Dec. 25, 2003

(54) Slot guards

(76) Inventor: Margaret Rose Hoston-Fountain, Gary, IN (US)

Correspondence Address: Margaret Rose Hoston- Fountain, 1737 Jefferson Street Apt. 1, Gary, IN, 46407, US

(21) Appl. No.: 10/095,760

(22) Filed: Jun. 24, 2002

(51) Int. Cl. G09F 7/00

(52) U.S. Cl. 40/584

(57) ABSTRACT

This Information Summary relates to a product idea called “Slot Guards” which has been disclosed by Ms. Margaret R. Fountain of Gary, Ind. It is based upon information submitted by the originator along with notes from conversations with interested representatives. General marketing information tailored to “Slot Guards” has been supplied and appropriate suggestions made. Standard statistical data with a heavy orientation on material prepared by the U.S. Department of Commerce and the Bureau of the Census was utilized. This data was supplemented with more specialized information available from other basic marketing reference works, trade associations, trade publications, libraries, and other sources. The results is a reference tool which can be used to submit “Slot Guards” to industry in a logical format which stresses its positive and most appealing features.

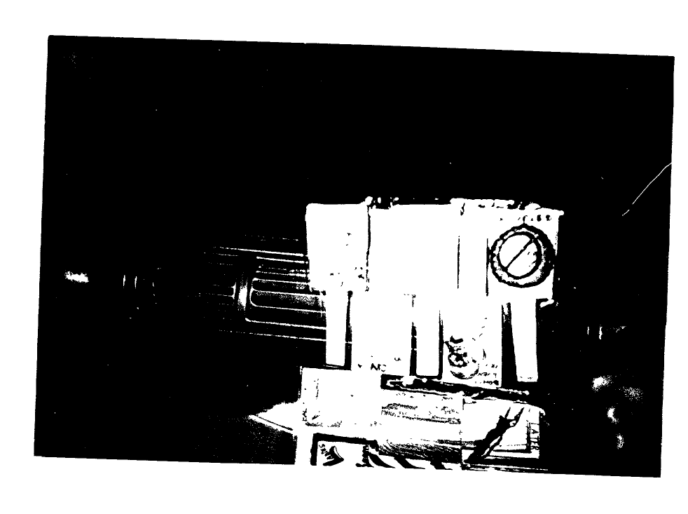

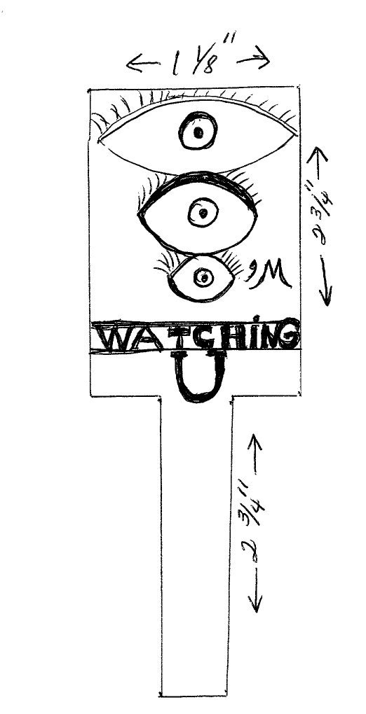

### CROSS-REFERENCE TO RELATED APPLICATIONS

Re:: application Ser. No.: 10/095,760 Filing/Receipt Date: Mar. 13, 2002

### STATEMENT REGARDING FEDERALLY SPONSORED RESEARCH

Pursuant to your request, a preliminary patent ability search for the Above-identified invention has been conducted through the available official files and records of the United States Patent and Trademark Office. The search was Limited to issued United States patents (from the year 1790 to present). No foreign patents or publications were reviewed, and although such items may be relevant, no effort was made to determine the existence of similar products in the market place. The search has been conducted to assist you in determining whether utility or design patent protection, or both for your invention might be available.

### REFERENCE TO SEQUENCE LISTING, A TABLE, OR A COMPUTER PROGRAM LISTING COMPACT DISK APPENDIX

“Not Applicable”

### BACKGROUND OF THE INVENTION

The “Slot Guards” were first inspired by personal experience. While playing the slot machines the applicant found it annoying that other patrons would take the applicant's slot machine when going to the bathroom or otherwise left briefly. The idea of a device that would reserve the slot machine in the absence of a patron was conceived. Thus, the brainstorming resulted in “Slot Guards”.

U.S. Pat. No. 4,572,510/Inventor(s): Green

The utility patent to Green is considered to be a very relevant prior art Reference discovered during the search. This patent effectively discloses an Invention which performs a function similar to the function performed by the novelty sign comprising the present invention. However, the structure of the invention shown in Green is different from that of this invention, and a patentable distinction can be made. The Green reference also provides a good example of the amount of written and illustrated description required to obtain utility patent protection for your type of invention.

U.S. Pat. No. 6,055,755/Inventor(s): Prokes

The utility patent to Prokes has been provided as another example of an invention which is related to the present invention and is relevant to the extent that a similar function is disclosed. Structural differences between this invention and the invention shown in the patent document to Prokes are evident however, and this patent, either considered alone or in combination with the patent document Green, should not preclude the seeking of patent protection for the novelty sign of the present invention. The Prokes reference offers another good example, as does the Green patent, of the amount of written and illustrated description required to obtain utility patent protection in the United States.

U.S. Pat. Des. No. 407,118/Inventor(s): Whitten

The design patent to Whitten has been provided as another example of an invention which is related to the present invention, and it is relevant to the extent that it most likely illustrates an invention which performs a similar function. There are still structural differences between this invention and the patent documents to Green, Prokes, and Whitten, whether considered alone or in combination with each other, and accordingly, these patent documents should not prevent a reasonably good chance of obtaining patent protection for this invention. The Whitten patent is also illustrative of how design patent protection can be obtained for this type of invention.

U.S. Pat. No. 5,488,656/Inventor(s): DeArkland

U.S. Pat. No. 4,513,968/Inventor(s): Okada

U.S. Pat. No. 5,114,157/Inventor(s): Kita

The remaining patents to DeArkland, Okada and Kita are provided as being of general interest and are also pertinent to the construction and design of the invention. They have been included as being further indicative of the current state of the art. These patents, whether reviewed individually or in combination with each other, or with the patents to Green, Prokes, and Whitten, do not render obviously the the novelty sign of the present invention.

### BRIEF SUMMARY OF THE INVENTION

The concepts of “Slot Guards” is a line of novelty devices which would be used to reserve a slot machine. This device would be intended to provide a convenience item for casino patrons or for consumers who play games that utilize coins, such as video poker and slot machines.

### BRIEF DESCRIPTION OF THE SEVERAL VIEWS OF THE DRAWING

Captions are as Follows:

| | |
|---|---|
| 1. | Ladies Room |
| 2. | Come Back Later |
| | Alligator |
| 3. | What part of “Stop” |
| | don't you understand? |
| 4. | Occupied |
| 5. | Don't Even Try It |
| 6. | I'm Watching You |
| 7. | Back In A Flash |
| 8. | On A Mission |
| 9. | No Way Hosea |

### DETAILED DESCRIPTION OF THE INVENTION

Variations

The potential exists for varying production of “Slot Guards” in ways which could make them more appealing to a wider range of end users. This could include producing “Slot Guards” of various colors and with decorative designs. Various sizes could also be offered.

Producibility

“Slot Guards” could be produced easily using conventional and readily available materials and manufacturing processes. No new production technology would be required. They could be produced from a plastic such as polystyrene which is readily available in color, reasonably priced and easily formed by a wide range of plastic processors. Injection molding might be viewed as a standard approach to production also.

Concept

The “Slot Guards” would consist of plastic units that could be produced in various shapes and sizes. Each unit would feature a flat, thin bottom extension designed to fit into the coin slot of a slot machine. The tops of the units could feature imprinted phrases such as “On a Mission” or “Occupied”. To use the “Slot Guards”, a gambler would simply place the unit in the slot of the slot machine when he wishes to go to the bathroom or otherwise leave for a short period of time. With the sign in place, the user would have peace of mind that no other patron would begin playing his machine during his absence. This unit could also be imprinted with casino logos, thus allowing it to serve as a souvenir or collectible item.

1. What I claim as my invention is “Slot Guards” which would fulfill the need for a conveniece device that would serve to reserve a coin-operated gambling machine while a patron is away from the machine briefly and which would speed up the games, thereby keeping the players happy and also serve as a collectible souvenir item that can display whimsical phrases or casino logos.
